(19) United States
(12) Patent Application Publication
(10) Pub. No.: US 2009/0033886 A1
(43) Pub. Date: Feb. 5, 2009

(54) IMAGE PROJECTION SYSTEM FOR USE WITH A LIGHT POST

(76) Inventor: Brad G. Jones, Beverly Hills, CA (US)

Correspondence Address: STETINA BRUNDA GARRED & BRUCKER, 75 ENTERPRISE, SUITE 250, ALISO VIEJO, CA, 92656, US

(21) Appl. No.: 12/187,569

(22) Filed: Aug. 7, 2008

Related U.S. Application Data
(63) Continuation-in-part of application No. 11/881,929, filed on Jul. 30, 2007.

(51) Int. Cl. G03B 21/58; G03B 21/14

(52) U.S. Cl. 353/94; 353/122; 359/461

(57) ABSTRACT

There is provided an image projection system for use with a light post disposed adjacent a thoroughfare. The image projection system includes a projection device configured to project an image for observation by a viewer on the thoroughfare. A projection device support member is connected to the projection device and is also connectable to the light post. The image projection system also includes a display screen moveable between a deployed configuration and a stowed configuration. The display screen is disposed for observation by the viewer and in optical communication with the projection device to display the image projected by the projection device when in the deployed configuration. The display screen is withdrawn from view by the viewer when the display screen is in the stowed configuration. A display screen support member is connected to the display screen and is also connectable to the light post.

### CROSS-REFERENCE TO RELATED APPLICATIONS

This is a continuation-in-part application of application Ser. No. 11/881,929, filed on Jul. 30, 2007.

### STATEMENT RE: FEDERALLY SPONSORED RESEARCH/DEVELOPMENT

Not Applicable

### BACKGROUND

1. Field of the Invention

The present invention relates generally to an image projection system, and more specifically to an image projection system for use with a light post disposed adjacent a thoroughfare.

2. Description of the Prior Art

Advertising and marketing displays are commonly hung from conventional light posts positioned along a street or sidewalk. For instance, banners or signs may hang from the light post to inform the public of an upcoming community event, such as a parade or festival. Furthermore, banners may be hung from the light posts as decorations. Images of wreaths and snowmen may adorn banners in the winter months, while images of sailboats and beach balls may adorn the banners in the summer months. The banners may be positioned for view by the public as they walk down the sidewalk or drive down the street. This advertising and marketing technique may be used by a public entity, such as a city, along the city's streets or sidewalks. Furthermore, banners or posters may be hung by a private entity, such as in the parking lot of a mall or stadium.

A recurring problem with the banners and posters currently hung from light posts is their static nature. In other words, the image on the banner or posters cannot easily be changed. Therefore, once the banner is hung on the light post, the image on the banner remains on display until the banner is removed. Consequently, the banner may require replacement several times each year to keep the image or message up to date. Considerable time and expense may be expended to change the banners throughout the year.

Furthermore, many individuals have grown accustomed to highly sophisticated image displays. For instance, many households include one ore more high-definition televisions. In addition, stadiums typically include one or more jumbotrons for displaying images. Furthermore, some billboards include sophisticated image displays capable of projecting videos or quickly changing images. Therefore, simple banners and posters hung on light posts may no longer capture the public's attention.

As is apparent from the foregoing, there is a need in the art for an improved image projection system for use with a light post. The present invention addresses this particular need, as will be discussed in more detail below.

### BRIEF SUMMARY

There is provided an image projection system for use with a light post disposed adjacent a thoroughfare. The image projection system includes a projection device configured to project an image for observation by a viewer on the thoroughfare. A projection device support member is connected to the projection device and is also connectable to the light post. The image projection system also includes a display screen moveable between a deployed configuration and a stowed configuration. The display screen is disposed for observation by the viewer and in optical communication with the projection device to display the image projected by the projection device when in the deployed configuration. The display screen is withdrawn from view by the viewer when the display screen is in the stowed configuration. A display screen support member is connected to the display screen and is also connectable to the light post.

The image projection system may be used to project an image that is not as permanent in nature as those included on banners and signs hung from street lights. In other words, the image may be quickly and easily changed by projecting another image by the projection device. The projection device may be capable of displaying images in a slideshow mode or a video mode. Furthermore, the projection device may employ a liquid crystal display, a laser projection display, a cathode ray tube, a digital light processing, a liquid crystal on silicon device, a light emitting diode device, and a plasma device. The image may be a three-dimensional image, such as a hologram, and the image may be either static or dynamic.

The display screen may be formed of a flexible material, such as a fabric or netting material. The display screen may be biased towards the stowed configuration. The display screen support member may include a screen stowing element configured to collect the display screen as the display screen moves toward the stowed configuration. The screen stowing element may include a rod that is rotatable. The display screen may move between the stowed and deployed configurations as the rod rotates. The rod may rotate in a first direction to move the display screen toward the deployed configuration, and in a second direction to move the display screen toward the stowed configuration.

There is also provided a method of displaying an image adjacent a light post disposed adjacent a thoroughfare. The light post having a light post shaft and a light source connected to the light post shaft. The light post shaft is connected to a foundation. The method includes the step of providing a projection device and a display screen. The projection device is configured to project an image for observation by a viewer on the thoroughfare. The display screen is configured to display the image projected by the projection device. The display screen is moveable between a deployed configuration and a stowed configuration. The projection device is connected to the light post shaft. The display screen is also connected to the light post shaft. The display screen is positioned to be exposed for observation by a viewer and in optical communication with the projection device to display the image projected by the projection device when in the deployed configuration. The display screen is withdrawn from view by the view when in the stowed configuration.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a side elevation view of an image projection system connected to a light post;

FIG. 2 is front elevation view of the image projection system depicted in FIG. 1;

FIG. 3 is a partial front elevation view of the image projection system illustrated in FIGS. 1 and 2, wherein the image projection system includes a display screen being moveable between a deployed configuration and a stowed configuration;

FIG. 4 is a side elevation view of the image projection system illustrated in FIG. 3; and

FIG. 5 is a front elevation view of an image projection system including a first display screen and a second display screen.

### DETAILED DESCRIPTION

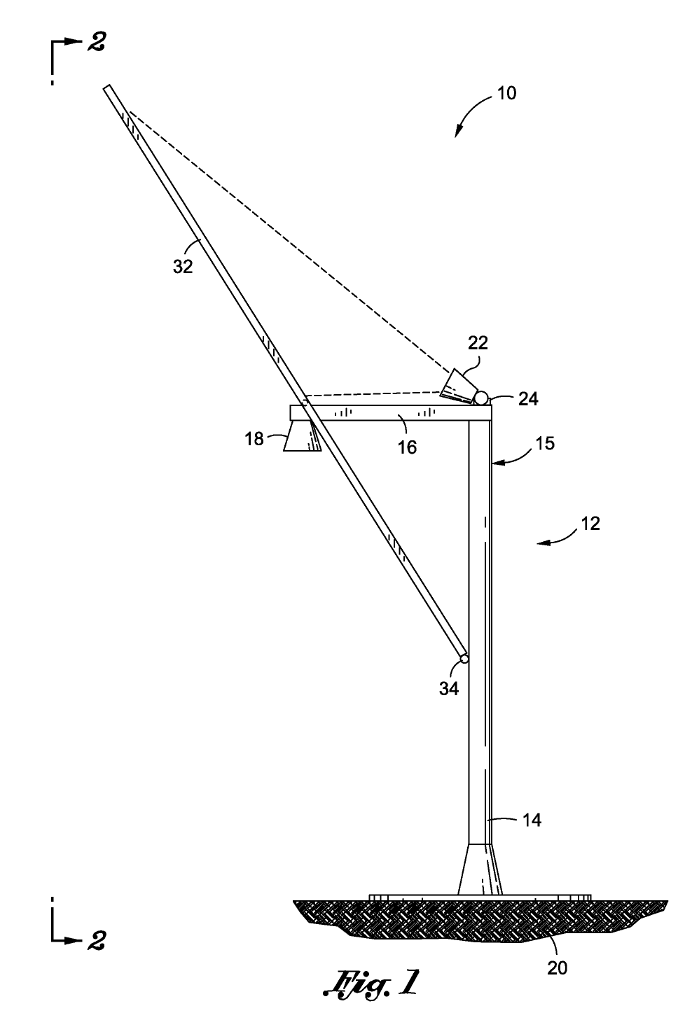

Referring now to the drawings wherein the showings are for purposes of illustrating a preferred embodiment of the present invention only, and not for purposes of limiting the same, FIG. 1 depicts an image projection system 10 constructed in accordance with an embodiment of the present invention. According to various aspects of the present invention, the image projection system 10 is configured to be used with a light post 12. As used herein, a light post 12 may include any structure disposed on or adjacent to a thoroughfare. In one embodiment, the light post 12 includes a shaft 15 having light post base portion 14 and a light post cantilever portion 16 extending from the light post base portion 14. The light post base portion 14 is connected to a foundation 20. The light post 12 depicted in FIG. 1 includes a light source 18 for illuminating in the area adjacent the light post 12. However, it is understood that several embodiments of the invention may include a light post 12 that does not include a light source 18. As such, the light post 12 may simply include a rod protruding from a foundation 20. In this manner, the primary purpose of the light post 12 may be for advertising, conveying a message, or decorating, and not illuminating an area. The light post 12 may extend from the ground or from a building or structure located on or adjacent the thoroughfare.

As used herein, a thoroughfare refers to a passageway or other commonly populated area. Exemplary thoroughfares include, but are not limited to, streets, sidewalks, paths, walkways, driveways, parking lots, or hallways. In this manner, thoroughfares may be located both inside (e.g. hallway) and outside (e.g. street) of a structure. Thoroughfares may also include waterways such as rivers or lakes. In this manner, light post 12 may be disposed along the shoreline of the river or lake, or connected to a buoy anchored in the river, lake, or other water passageway. With regard to streets, sidewalks, and other vehicular and pedestrian passageways, the light post 12 may extend over a portion of the thoroughfare. The light post 12 may also be disposed within the middle of the thoroughfare. For instance, the light post 12 may be located in the median of a road. In general, the light post 12 is positioned to be viewable by viewers located on the thoroughfare.

The image projection system 10 includes a projection device 22 configured to project an image for observation by a viewer on the thoroughfare. In this regard, the image may be viewable by viewers physically located on the thoroughfare, or in an area immediately adjacent the thoroughfare. For instance, if the thoroughfare is a sidewalk, the image may be viewable to people on the sidewalk or adjacent to the sidewalk.

The projection device 22 may include slide projectors, movie projectors, rear projectors, front projectors, overhead projectors or other projectors known by those skilled in the art. The format of the image projected by the projection device may be audio visual, NTSC, high-definition, wide screen, overhead, slide or motion picture. In this manner, the projection device 22 may be configured to display slides, VHS movies, DVD movies, or other data files containing images. According to one embodiment, the projection device 22 includes a data input configured to receive a data file containing an image. The data input may be configured to engage with a USB device, a computer, the Internet, an intranet or other local network. The data input may also be configured to receive data files over wireless data transmission. Such wireless transmission may be achieved using Bluetooth® technology, or other wireless technologies known by those skilled in the art.

The image projected by the projection device 22 may vary as desired by the user. The projection device 22 may be configured to project a static image, or a dynamic image. In other words, the image may include a single picture that does not change, or a series of pictures such as a slide show. The image may also include a video projected by the projection device 22. The image may also include a single textual message which may include letters and/or numbers (e.g., “Happy Holidays”). The projection device 22 projects the image in a viewable manner.

The image projection system 10 also includes a projection device support member 24 for connecting the projection device 22 to the light post 12. The projection device support member 24 is sized and configured to connect with to the projection device 22 and also be connectable to the light post 12. Therefore, the projection device support member 24 may be detached from the light post 12 to remove the projection device 22 therefrom. In one embodiment, the projection device support member 24 is integrally formed with the projection device 22. In another embodiment, the projection device support member 24 may be fastened to the projection device 22 by a mechanical fastener, such as a screw or nail, or may be fastened to the projection device 22 by a snap fit engagement. Other fastening means known by those skilled in the art may also be used without departing from the spirit and scope of the present invention.

The projection device support member 24 may include structural attributes for facilitating engagement with the light post 12. In one embodiment, the projection device support member 24 includes a clamp configured to engage with the light post 12. The clamp may be biased toward a closed position to clamp onto the light post 12. In order to remove the projection device support member 24 from the light post 12, the clamp may be moved from a closed position toward an open position to release from the light post 12. In another embodiment, the projection device support member 24 may include an aperture which may be aligned with an aperture formed in the light post 12. A mechanical fastener, such as a nut and bolt, or a rivet may be disposed through the apertures within the projection device support member 24 and the light post 12 to fasten the projection device support member 24 to the light post 12. In other embodiments, an adhesive may be used to connect the projection device support member 24 to the light post 12. Other connection techniques known by those skilled in the art may also be used to connect the projection device support member 24 to the light post 12.

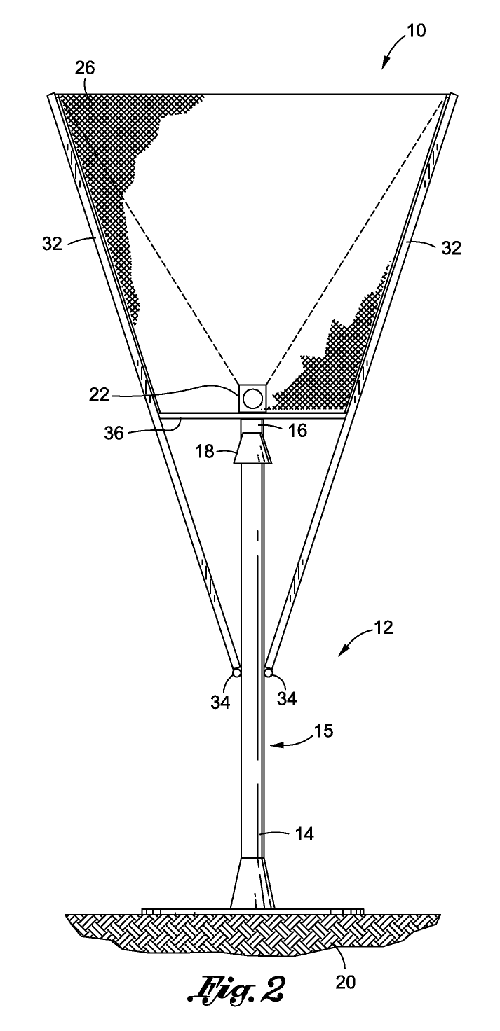

Referring now to FIG. 2, the image projection system 10 includes a display screen 26 for displaying the image projected by the projection device 22. The display screen 26 may define a substantially planar surface for displaying the image projected by the projection device 22. As depicted in FIG. 2, the display screen 26 is comprised of a netting material. It is understood that other materials capable of displaying the image may be used, such as matte white vinyl material, or a pearlescent silver or glass bead material.

The display screen 26 is positioned in optical communication with the projection device 22. In this manner, the image projected by the projection device 22 is projected onto the display screen 26. The projection device 22 may be pivotable in multiple planes to bring the projection device 22 and display screen 26 in optical communication with each other.

One or more display screen support members 32 may be used to provide support for the display screen 26. In the particular embodiment depicted in FIG. 2, a pair of display screen support members 32 is used to support the display screen 26. Each display screen support member 32 is connected to the light post 12 by a support pivot 34. In the embodiment illustrated in FIG. 2, a support cross bar 36 extends between the display screen support members 32.

As shown, the display screen support members 32 are connected to the lateral side portions of the display screen 26. Other support configurations known in the art may also be used. For instance, the screen 26 may be supported by a support member 32 disposed above the screen 26. In this manner, the screen 26 may hang from the display screen support member 32.

The distance between the display screen 26 and the projection device 22 may be altered to bring the image into focus. Referring again to FIG. 1, the display screen support members 32 may pivot about the support pivot 34 to move the display screen 26 relative to the projection device 22. Additionally, the projection device support member 24 may be moved along the light post 12 to position the projection device 22 in a position to bring the image into focus on the display screen 26.

The display screen 26 may be configured to display an image projected by the projection device 22 on a surface facing away from the projection device 22. This is similar to a conventional television, where an image is projected from within the television set and is viewable by a viewer located in front of the television set. In other words, the display screen 26 may be disposed between the projection device 22 and the viewer. In this manner, the display screen 26 may be somewhat transparent to allow for transmission of the image therethrough. In other embodiments, the display screen 26 may be configured to display the image on a surface facing toward the projection device 22. This configuration is similar to a conventional movie theater where the image is projected onto the same surface which the audience views.

In the embodiment illustrated in FIG. 2, the display screen 26 is disposed between the display screen support members 32 to maintain the display screen 26 in a position for displaying the image projected by the projection device 22. The display screen 26 depicted in FIG. 2 is maintained in that position until it is removed from the display screen support members 32. Therefore, the display screen 26 may be configured easily connected to, or disengage from the display screen support members 32. In this regard, snap fit buttons may be used to connect the display screen 26 to the display screen support members 32. The display screen 26 may also include a flange which is received within a slot formed within the display screen support members 32. Other mechanical fastening means may also be used without departing from the spirit and scope of the present invention.

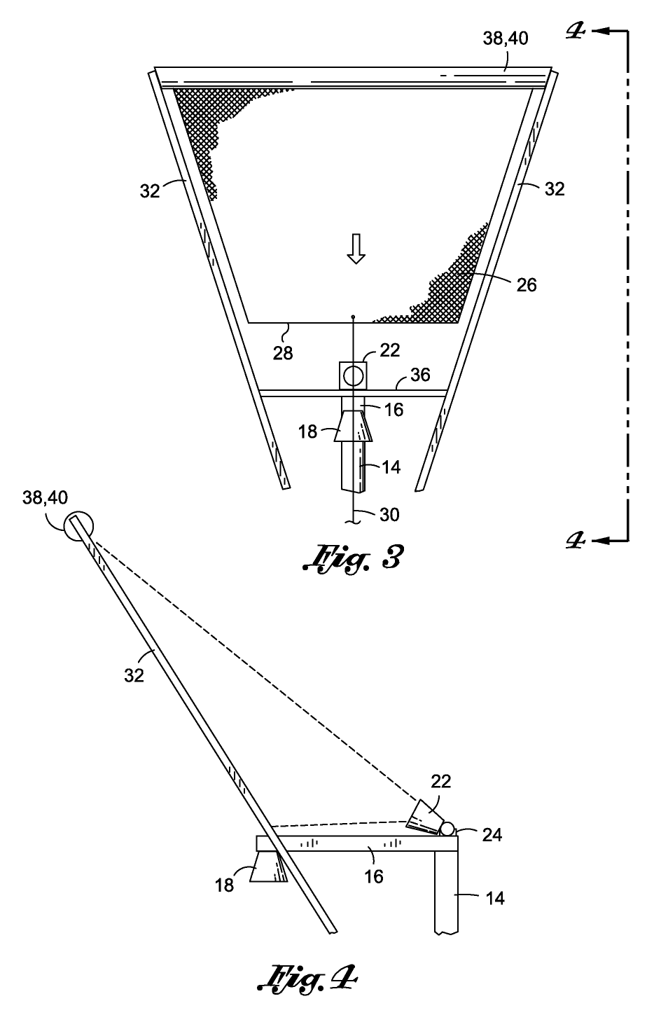

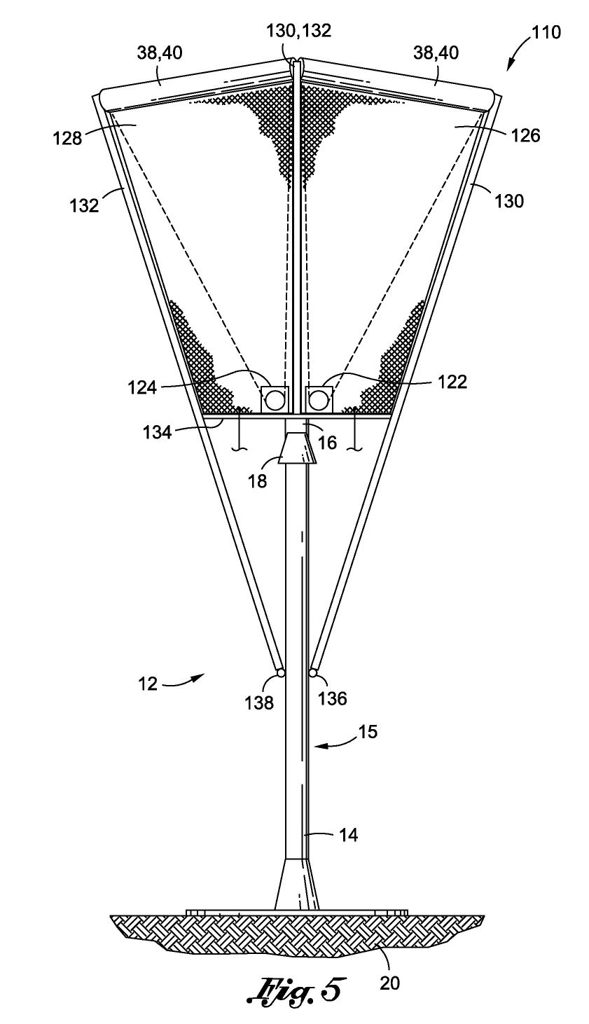

Referring now to the embodiments shown in FIGS. 3 and 4, the display screen 26 is movable between a deployed configuration and a stowed configuration. The display screen 26 is exposed for observation by the viewer and an optical communication with the projection device 22 to display the image projected by the projection device 22 when in the deployed configuration. The display screen 26 is withdrawn from view by the viewer and is removed from optical communication with the projection device 22 when in the stowed configuration.

A screen stowing element 38 may be used to facilitate movement of the display screen 26 between the deployed configuration and the stowed configuration. In the particular embodiment illustrated in FIGS. 3 and 4, the screen stowing element 38 includes a rod 40 connected to the display screen 26 and rotatable in first and second directions to move the display screen 26 between the deployed and stowed configurations. The rod 40 extends between the pair of display screen support members 32 and is rotatably connected thereto. The rod 40 rotates in a first direction to move the display screen 26 toward the deployed configuration and in a second direction to move the display screen 26 toward the stowed configuration. A pull string 30 disposed adjacent a display screen edge 28 may be used to pull the display screen 26 toward the deployed configuration. In another embodiment, a drive motor may be employed to move the display screen 26 between the deployed and stowed configurations.

In one embodiment, the screen stowing element 38 is biased to move the display screen 26 toward the deployed configuration or the stowed configuration. For instance, the rod 40 may be biased to rotate in the second direction to move the display screen 26 toward the stowed configuration. In this manner, a user may pull on the pull string 30 to overcome the biasing force to move the display screen 26 toward the deployed configuration. The pull string 30 may be tied around the support member 32 or portions of the light post 12 to maintain the display screen 26 in the deployed configuration. Alternatively, a locking mechanism may be used to lock the screen stowing element 38 when the display screen 26 is in the deployed configuration. In other words, when the display screen 26 is fully deployed, the screen 26 may not be biased toward the stowed configuration until the locking mechanism is disengaged. The locking mechanism may be disengaged by a release button or by simply pulling on the display screen, similar to a conventional window shade. Once the locking mechanism is disengaged, the display screen 26 may move toward the stowed configuration.

Although the embodiment depicted in FIGS. 3 and 4 includes a rod 40 as a screen stowing element 38, other screen stowing elements such as a housing may be used to store the screen 26 in the stowed configuration. In another embodiment, the display screen 26 may be connected to a banner which is connected to two rollers. The display screen 26 may only occupy a portion of the banner, while another portion of the banner may be configured to be exposed when the display screen is in the stowed configuration. The rollers may rotate to move the display screen portion of the banner into optical communication with the projection device 22. When the display screen 26 is not being used, the rollers may rotate the banner to bring another portion of the banner into optical communication with the projection device 22. The other portions of the banner may be better suited to handle the wind, rain, snow, ice, or vandalism which may be encountered.

Referring now to the embodiment illustrated in FIG. 5, there is shown an image projection system 110 having multiple display screens 126, 128. In particular, the image projection system 110 includes a first display screen 126 and a second display screen 128. The first display screen 126 is used in connection with a first projection device 122 while the second display screen 128 is used in connection with a second projection device 124. A first display screen support member 130 connects the first display screen 126 to the light post 12 while a second display screen support member 132 connects the second display screen 128 to the light post 12. The first display screen support member 130 is connected to the light post 12 by a first support pivot 136 and the second display screen support member 132 is connected to the light post 12 by a second support pivot 138. A support cross bar 134 extends between the first and second display screen support members 130, 132.

It may be desirable to include multiple display screens to display multiple images at a single time. In addition, the multiple display screens may be used to display images to viewers in different locations. For instance, as shown in FIG. 5, the first and second display screens 126, 128 are arranged in a v-shaped configuration. In this manner, the first display screen 126 may be configured to display an image to viewers traveling along the thoroughfare in a first direction while the second display screen 128 may be configured to display an image to viewers traveling along the thoroughfare in a second direction.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An image projection system for use with a light post disposed adjacent a thoroughfare, the light post having a light post shaft and a light source connected to the light post shaft, the light post shaft being connected to a foundation, the image projection system comprising:
a projection device configured to project an image for observation by a viewer on the thoroughfare;
a projection device support member connected to the projection device and connectable to the light post shaft;
a display screen being moveable between a deployed configuration and a stowed configuration, the display screen being exposed for observation by the viewer and in optical communication with the projection device to display the image projected by the projection device when in the deployed configuration, the display screen being withdrawn from view by the viewer when in the stowed configuration; and
a display screen support member connected to the display screen and connectable to the light post shaft.

2. The image projection system as recited in claim 1 wherein the display screen support member is sized and configured to dispose the display screen above the light post when the display screen is in the deployed position.

3. The image projection system as recited in claim 1 wherein the display screen is formed of a flexible material.

4. The image projection system as recited in claim 1 wherein the display screen is biased toward the stowed configuration.

5. The image projection system as recited in claim 1 wherein the display screen support member includes a screen stowing element configured to collect the display screen as the display screen moves toward the stowed configuration.

6. The image projection system as recited in claim 5 wherein the screen stowing element includes a rod being rotatable, the display screen moving between the stowed configuration and the deployed configuration as the rod rotates.

7. The image projection system as recited in claim 6 wherein the rod rotates in a first direction to move the display screen toward the deployed configuration and in a second direction to move the display screen toward the stowed configuration.

8. The image projection system as recited in claim 7 wherein the rod is biased toward the second direction.

9. The image projection system as recited in claim 1 wherein the image projected by the projection device is a static image.

10. The image projection system as recited in claim 1 wherein the image projected by the projection device is a dynamic image.

11. An image projection system for use with a light post disposed adjacent a thoroughfare, the light post having a light post shaft and a light source connected to the light post shaft, the light post shaft being connected to a foundation, the image projection system comprising:
a first projection device configured to project a first image for observation by a viewer on the thoroughfare, the first projection device being connectable to the light post shaft;
a second projection device configured to project a second image for observation by a viewer on the thoroughfare, the second projection device being connectable to the light post shaft;
a first display screen being moveable between a deployed configuration and a stowed configuration, the first display screen being exposed for observation by the viewer and in optical communication with the first projection device to display the image projected by the first projection device when in the deployed configuration, the first display screen being withdrawn from view by the viewer when in the stowed configuration;
a first display screen support member connected to the first display screen and connectable to the light post shaft, the first display screen support member being sized and configured to dispose the first display screen above the light post when the first display screen is in the deployed position;
a second display screen being moveable between a deployed configuration and a stowed configuration, the second display screen being exposed for observation by the viewer and in optical communication with the second projection device to display the image projected by the second projection device when in the deployed configuration, the second display screen being withdrawn from view by the viewer when in the stowed configuration; and
a second display screen support member connected to the second display screen and connectable to the light post shaft, the second display screen support member being sized and configured to dispose the second display screen above the light post when the first display screen is in the deployed position.

12. The image projection system as recited in claim 11 wherein the first and second display screens are arranged in a v-shaped configuration.

13. The image projection system as recited in claim 11 wherein the first display screen support member includes a first screen stowing element configured to collect the first display screen as the first display screen moves toward the stowed configuration.

14. The image projection system as recited in claim 13 wherein the second display screen support member includes a second screen stowing element configured to collect the second display screen as the second display screen moves toward the stowed configuration.

15. The image projection system as recited in claim 11 wherein the first display screen is biased toward the stowed configuration.

16. The image projection system as recited in claim 15 wherein the second display screen is biased toward the stowed configuration.

17. A method of displaying an image adjacent a light post disposed adjacent a thoroughfare, the light post having a light post shaft and a light source connected to the light post shaft, the light post shaft being connected to a foundation, the method comprising the steps of:
(a) providing a projection device and a display screen, the projection device configured to project an image for observation by a viewer on the thoroughfare, the display screen configured to display the image projected by the projection device, the display screen being moveable between a deployed configuration and a stowed configuration;
(b) connecting the projection device to the light post shaft; and
(c) connecting the display screen to the light post shaft, the display screen being positioned to be exposed for observation by a viewer and in optical communication with the projection device to display the image projected by the projection device when in the deployed configuration, the display screen being withdrawn from view by the view when in the stowed configuration.

18. The method as recited in claim 17 wherein step (a) includes providing a display screen formed of a flexible material.

19. The method as recited in claim 17 wherein step (a) includes providing a display screen that is biased toward the stowed configuration.

20. The image projection system as recited in claim 17 wherein step (a) includes providing a projection device configured to project a dynamic image.
